(19) United States
(12) Patent Application Publication
(10) Pub. No.: US 2026/0176112 A1
(43) Pub. Date: Jun. 25, 2026

(54) CRANE ARM AND A WORKING EQUIPMENT

(71) Applicant: Hiab AB, Malmö (SE)

(72) Inventors: Martin Sigrand, Trangsund (SE); Lars Elsmark, Saltsjö-Boo (SE)

(21) Appl. No.: 19/419,505

(22) Filed: Dec. 15, 2025

(30) Foreign Application Priority Data
Dec. 19, 2024 (EP) 24221586.1

(51) Int. Cl. B66C 23/70; B66C 23/36

(52) U.S. Cl. CPC B66C 23/706; B66C 23/36

(57) ABSTRACT

The disclosure relates to a crane arm (100) comprising: a first boom (10) configured to be movably connected to a crane assembly (1) for supporting the crane arm (100); a second boom (20) movably connected to the first boom (10), a set of electrically powered actuators (50) powered by AC power signals, the set of actuators (50) comprising at least a first actuator (52) with a first electric motor (62) and a second actuator (54) with a second electric motor (64), wherein the first actuator (52) is arranged to move the first boom (10) in relation to the crane assembly (1) and the second actuator (54) is arranged to move the second boom (20) in relation to the first boom (10), wherein the crane arm (100) further comprises a power distribution assembly (70) including an interface (72) for receiving a DC power signal; and a set of spatially distributed power converting units (80) arranged to convert the DC power signal to an AC power signal for a respective electric motor (62, 64) of the set of actuators (50), wherein each power converting unit of the set of power converting units (80) is arranged adjacent to the respective electric motor (62, 64).

### CROSS-REFERENCE TO RELATED APPLICATIONS

This application claims priority to European Application No. 24221586.1, filed Dec. 19, 2024, the contents of which are hereby incorporated herein in its entirety by reference.

### TECHNICAL FIELD

The present disclosure relates to a crane arm and a working equipment. More specifically, the disclosure relates to a crane arm and a working equipment as defined in the introductory parts of the independent claims.

### BACKGROUND ART

Working equipment, such as cranes, loader cranes, excavators, dumpers, demountables, hooklifts, forklifts and tail lifts, typically comprise hydraulic cylinders for lifting and lowering operations. Hydraulic cylinders have many advantages, but hydraulic machinery generally suffers from big energy losses. The hydraulic cylinders are driven by hydraulic fluid under pressure, which may be generated by hydraulic pumps driven by a combustion engine in the vehicle. The general trend for electrification leading to combustion engines being replaced by electric engines, powered by e.g. batteries in vehicles such as trucks also highlights the need for energy efficiency for the working equipment that is mounted to the vehicles.

Electrically powered actuators, such as electro-mechanical actuators (EMAs) or electro-hydraulic actuators (EHAs) are used in different applications and are typically used to move objects between different positions. An electro-mechanical actuator may comprise a rotating electric motor and a mechanical transmission to convert the rotational speed and torque of the motor to a linear motion. Such mechanical transmission may comprise a gearbox and a screw shaft. The electric motor comprises a stator and a rotor, wherein the rotor of the electric motor is configured to generate a linear movement of the screw shaft. Using such electro-mechanical actuators also in working equipment has started to become more and more common.

Traditionally, crane arms with hydraulic cylinders have a centralized power architecture at the working equipment with one hydraulic pump and a hydraulic valve block to control all the functions on the working equipment. When changing from hydraulic actuators to electrically powered actuators, such as EMAs, there are a number of challenges. One challenge is how to power the actuators efficiently with good thermal management. A hydraulic system is by design not only providing power through the pipes it is also providing cooling through the oil.

There is thus a need for an improved solution for working equipment with electrically powered actuators, which eliminates the deficiencies and disadvantages with prior art.

### SUMMARY

It is an object of the present disclosure to mitigate, alleviate or eliminate one or more of the above-identified deficiencies and disadvantages in the prior art and solve at least the above-mentioned problem.

It is a further objective of the present invention to achieve a crane arm and a working equipment comprising electrically powered actuators, which has an improved power architecture and improved thermal management.

These objectives are achieved with the above-mentioned crane arm and working equipment according to the appended claims.

According to a first aspect there is provided a crane arm comprising a first boom configured to be movably connected to a crane assembly for supporting the crane arm; a second boom movably connected to the first boom, a set of electrically powered actuators powered by AC power signals, the set of actuators comprising at least a first actuator with a first electric motor and a second actuator with a second electric motor, wherein the first actuator is arranged to move the first boom in relation to the crane assembly and the second actuator is arranged to move the second boom in relation to the first boom, wherein the crane arm further comprises a power distribution assembly including an interface for receiving a DC power signal; and a set of spatially distributed power converting units arranged to convert the DC power signal to an AC power signal for a respective electric motor of the set of actuators, the set of power converting units comprising at least a first power converting unit for the first electric motor and a second power converting unit for the second electric motor, wherein each power converting unit of the set of power converting units is arranged adjacent the respective electric motor of the set of actuators.

A crane arm comprising two booms will require at least two actuators. One to move the first boom of the crane arm in relation to the crane assembly and a second actuator to move the second boom in relation to the first boom. When using electrically powered actuators including electric motors, each motor will be powered by AC power signals and power converting units will be required to convert DC power signals to AC power signals. The power converting units may also be referred to as inverters. By arranging the power converting units adjacent their respective electric motor instead of arranging all converting units in the foot of the crane, a decentralized power architecture is achieved and the cabling distance between the power converting units and the electric motors will be drastically decreased. The cabling between the power converting units and the electric motors comprises 3-phase Pulse Width Modulation, PWM, cables and thus three different cables are required between each power converting unit and its electric motor. By decentralizing the position of the power converting units and positioning them closer to their respective electric motor, less cabling between the power converting unit and the electric motor will be required. Longer High-Voltage, Direct Current, HVDC, cables between the interface for receiving the DC power signal from a DC power source and each power converting unit will be required, but since that is only one cable, the total amount of cabling will be reduced. Thus, the cabling distance between the power converting unit and the electric motor will be shorter than the cabling distance between the DC power source and the interface and the power converting unit. With less cabling, the routing of the cables along the booms (either internally or externally) and around the boom joints will become less challenging. This further improves the safety and makes servicing the crane arms easier. The internal weight of the crane arm will further be reduced and with less space requirements for cables a slimmer design of the crane booms may be achieved. Furthermore, by arranging the power converting units spatially distributed on the crane structure, the heat sources will be spread out and the productivity and the maximal power of the crane arm will be increased. To mount the power converting units directly on the crane arm will make the crane arm a heat exchanger.

The set of electrically powered actuators may comprise electro-mechanical actuators and/or electro-hydraulic actuators.

An electro-mechanical actuator may comprise a translation assembly including a rotatable part and a linearly movable part connected to each other to translate a rotating movement of the rotatable part to a linear movement of the linearly movable part. It also comprises an electric motor connected to the rotatable part to provide the rotating movement of the rotatable part. Each electro-mechanical actuator may comprise a first end part and a second end part, wherein the linearly movable part comprises the second end part. The first end part is typically connected to one part of the crane structure and the second end part is connected to another moveable part of the crane structure. When the rotatable part of the actuator is rotated, the rotating movement is translated into a linear movement of the linearly moveable part and the distance between the first end part and the second end part of the actuator increases or decrease depending on the rotational direction of the rotatable part. This way, the different parts of the crane structure will move in relation to each other.

The linearly moveable part may comprise an actuating rod or screw shaft with outer threads. The linearly moveable part is typically received within the rotatable part, which could be a threaded cylinder or similar. Exactly how the translation assembly of an electro-mechanical actuator is configured to translate the rotating movement to a linear movement will not be described herein. It is to be understood that such translation assembly could be configured in many different ways and is not part of the present invention.

The first actuator is connected to the first boom of the crane arm and to the crane assembly to which the first boom is connected. The connection between the actuator and boom and/or crane assembly may either be directly or through one or more mechanical links. Specifically, the first actuator may comprise a first end part connected to the crane assembly and a second end part connected to the first boom. This way, the linear movement of the linearly movable part of the first actuator will move the first boom in relation to the crane assembly. The second actuator is connected to the first boom and to the second boom. These connections between the actuator and the booms may either be directly or through one or more mechanical links. Specifically, the second actuator may comprise a first end part connected to the first boom and a second end part connected to the second boom. This way, the linear movement of the linearly moveable part of the second actuator will move the second boom in relation to the first boom. The electric motor of each actuator may be arranged at the first end part of the respective actuator.

The power distribution assembly of the crane arm is operably connectable to a DC power source via the interface for receiving a DC power signal. The DC power source may be a battery, an accumulator or the electric mains. The battery referred to herein may e.g. be a battery dedicated for the crane arm, a battery located at the working equipment, or a battery located at a vehicle, such as a truck, to which the crane arm of the working equipment is mounted. The battery referred to herein may further be a plurality of batteries or battery cells. The power distribution assembly further comprises a power input source configured to transfer the DC power signal to the power converting units. The power input source may also be referred to as a power supply. The DC power source will provide the DC power signal received by the interface of the power distribution assembly, and the DC power signal is forwarded to all converting units via the power input source.

According to some examples, the first and second power converting units are arranged on different parts of the crane arm or crane assembly, the different parts being arranged to move in relation to each other. The power converting units are arranged adjacent to the electric motor to which the converted power signal is provided. The electric motor of each actuator is typically arranged close to one end of the actuator and the corresponding power converting unit is thus also arranged close to one end of the actuator. Thus, the power converting unit being arranged adjacent its corresponding electric motor means that the power converting unit is substantially co-located with the corresponding electric motor. According to one example, the power converting unit and the electric motor may be integrated in the same physical unit.

In some examples, the second power converting unit is arranged on the first boom. The second actuator is thus arranged between the first boom and the second boom, and the first end part of the second actuator, where the second electric motor is positioned is, is at the first boom. Thus, the second power converting unit is positioned on the first boom. By arranging the second power converting unit on the first boom, the distance between the second power converting unit and the second electric motor is reduced.

In some examples, the first power converting unit is configured to be arranged on the crane assembly. Thus, the first actuator is arranged between the crane assembly and the first boom, wherein the first end part of the first actuator is arranged at the crane assembly. This way, the first electric motor of the first actuator will be arranged at the crane assembly. By arranging the first power converting unit on the crane assembly, the distance between the first power converting unit and the first electric motor is reduced.

The second boom may be a telescopic boom comprising at least one extendable and retractable third boom, wherein the set of actuators comprises a third actuator with a third electric motor arranged to move the third boom, and the set of power converting units comprises a third power converting unit arranged to convert the DC power signal to an AC power signal for the third electric motor. The third actuator is thus arranged between the second boom and the third boom and is configured to move the third boom in relation to the second boom. The third actuator may comprise a first end part connected to the second boom and a second end part connected to the third boom. The third power converting unit may be arranged on the second boom. Thus, the third power converting unit may be arranged adjacent the first end part of the third actuator and thus adjacent the third electric motor.

According to some examples, at least one power converting unit of the set of power converting units is arranged on the actuator associated with the electric motor receiving the AC power signal from the power converting unit. Thus, the first power converting unit may be arranged on the first actuator, the second power converting unit may be arranged on the second actuator and/or the third power converting unit may be arranged on the third actuator. This could be beneficial in the event that there is not enough mounting space on the crane structure itself. Furthermore, it may this way be guaranteed that the power converting unit is arranged close to the corresponding electric motor powering the actuator.

The power converting units of the set of power converting units may be connected in a connection sequence for distributing the DC power signal. The connection sequence of the power converting units may e.g. be implemented by connecting the power converting units in a parallel daisy chain for distributing the DC power signal or using a T-connection to connect the power converting units in parallel to the other units in the set of power converting units. This means that each power converting unit is connected to the same power input source, such as a common power bus or similar. This reduces the complexity of wiring and the power converting units will this way receive the same DC power signal simultaneously. The DC power signal will thereby be evenly distributed across all power converting units, which may be beneficial for load balancing and redundancy. Also, the cabling is further reduced, and it facilitates connection of further power converting units to the same power input source. Specifically, connecting the power converting units in a parallel daisy chain will further enhance the scalability of the power distribution assembly and allows for easy addition or removal of power converting units without significant reconfiguration. The parallel daisy chain setup provides flexibility, enabling the power distribution assembly to adapt to varying power demands and simplifying both installation and maintenance.

According to some examples, at least one power converting unit of the set of power converting units comprises an interface for connection with an additional power converting unit. This will facilitate adding additional power converting units to the power distribution assembly and also to the same power input source. The additional power converting unit may be configured to convert the DC power signal to an AC power signal for an electric motor of an actuator operating e.g. a crane tool or a jib connected to the crane arm. The jib may also be referred to as a jib arm and is an additional crane arm, often telescopic that can be attached to the crane arm. The additional power converting unit may in turn further be connected in a similar way as earlier described to further additional power converting units.

According to a second aspect of the present disclosure, there is provided a working equipment comprising a crane arm according to the first aspect. The working equipment comprises a crane assembly supporting the crane arm. The crane assembly comprises a crane base, a crane column and may further also optionally comprise further crane booms. The crane column may be rotatable by means of an electrically powered actuator and the power distribution assembly may comprise a power converting unit for an electric motor of such an actuator.

The working equipment may for example be a loader crane, forestry machine or crane, skip loader or a hook-lift, which may be used for applications in e.g. logistics, waste and recycling or forestry applications. The working equipment may further comprise working tools to e.g. pick up objects, dig, harvest etc., and hence be used in the work performed with the working equipment. The working tool may be mounted to an end of the crane arm. Examples of such working tools include grapples, clamshell buckets, buckets, brick grabs and grips. The working equipment may comprise an electrically powered actuator configured to operate the movements of the working tool to interact with objects or material to be picked up, harvested, collected etc. The power distribution assembly may thus comprise a power converting unit arranged to convert a DC power signal to an AC power signal for an electric motor of such an actuator. The working equipment may further comprise extendable stabilizer legs operated by electrically powered actuators powered by the power distribution assembly.

The working equipment may be configured to be arranged on a vehicle. The vehicle may be an electric driven vehicle. The vehicle may be propelled by a combustion engine. The vehicle may be an autonomous vehicle, or a semi-autonomous vehicle. The vehicle may further be a lorry or a truck.

The working equipment may comprise a DC power source operably connected to the power distribution assembly of the crane arm via the interface for receiving a DC power signal. Alternatively, the vehicle comprising the working equipment further comprises a DC power source operably connected to the power distribution assembly via the interface for receiving a DC power signal. The DC power source may be an electric battery or a system of several battery units.

The effects and features of the second aspect are to a large extent analogous to those described above in connection with the first aspect. Examples mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 schematically illustrates a crane arm mounted to a crane column according to an example of the present disclosure.

FIG. 2 schematically illustrates a crane arm mounted to a crane column according to an example of the present disclosure.

FIGS. 3a-b schematically illustrate a power distribution assembly of a crane arm according to examples of the present disclosure.

FIG. 4 schematically illustrates a vehicle with a working equipment according to an example of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

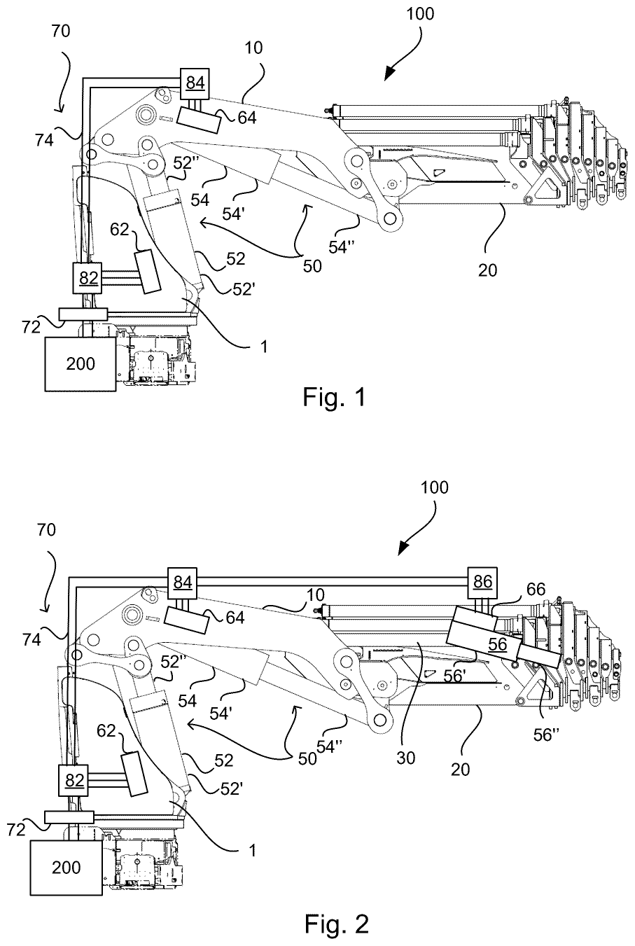

FIG. 1 schematically shows a crane arm 100 according to an example of the present disclosure. The crane arm 100 comprises a first boom 10 and a second boom 20. The first boom 10 is movably connected to a crane assembly 1, here illustrated by a crane column forming part of the crane assembly that is supporting the crane arm 100. The second boom 20 is movably connected to the first boom 10. The crane arm 100 further comprises a set of electrically powered actuators 50 powered by AC power signals. In this example, the set of actuators 50 comprises a first actuator 52 and a second actuator 54. The first actuator 52 is connected to the first boom 10 and to the crane assembly 1 to move the first boom 10 in relation to the crane assembly 1. The second actuator 54 is connected to the first boom 10 and to the second boom 20 to move the second boom 20 in relation to the first boom 10. The electrically powered actuators 52, 54 will herein be described as electro-mechanical actuators but it is to be understood that they alternatively could be electro-hydraulic actuators.

Each electro-mechanical actuator 52, 54 comprises a translation assembly including a rotatable part 52′, 54′ and a linearly movable part 52″, 54″ connected to each other to translate a rotating movement of the rotatable part 52′, 54′ to a linear movement of the linearly movable part 52″, 54″. Each electro-mechanical actuator 52, 54 further comprises an electric motor 62, 64 for rotating the rotatable part 52′, 54′, the first actuator 52 comprises a first electric motor 62 and the second actuator 62 comprises a second electric motor 64. The electric motors 62, 64 are co-located with the respective rotatable part 52′, 54′.

The crane arm 100 further comprises a power distribution assembly 70 including an interface 72 for receiving a DC power signal from a DC power source 200, and a set of spatially distributed power converting units 80 configured to convert the DC power signal to an AC power signal for the respective electric motor 62, 64 of the set of actuators 50. In this example, the set of power converting units 80 comprises a first power converting unit 82 for the first electric motor 62 of the first actuator 52 and a second power converting unit 84 for the second electric motor 64 of the second actuator 54. The power distribution assembly 70 further comprises a power input source 74, such as a power bus or similar. The power input source 74 transfers the DC power signal to the power converting units 82, 84.

Each power converting unit 82, 84 of the set of power converting units 80 is arranged adjacent the respective electric motor 62, 64. In this example, the first power converting unit 82 is arranged on the crane assembly 1 adjacent the first electric motor 62. The second power converting unit 84 is arranged on the first boom 10, adjacent the second electric motor 64. Even though it is not shown in this figure, at least one power converting unit 82, 84 of the set of power converting units 80 could be arranged on its corresponding actuator 52, 54.

FIG. 2 schematically shows a crane arm 100 according to an example of the present disclosure. The crane arm 100 is configured as disclosed in FIG. 1 but in this example, the set of actuators 50 further comprises a third actuator 56 arranged to move a third boom 30 in relation to the second boom 20. The third actuator 56 comprises a translation assembly including a rotatable part 56′ and a linearly movable part 56″ connected to each other to translate a rotating movement of the rotatable part 56′ to a linear movement of the linearly movable part 56″. The third electro-mechanical actuator 56 further comprises a third electric motor 66 for rotating the rotatable part 56′.

The set of power converting units 80 further comprises a third power converting unit 86 arranged to convert the DC power signal to an AC power signal for the third electric motor 66. The third power converting unit 86 is thus also connected to the power input source 74.

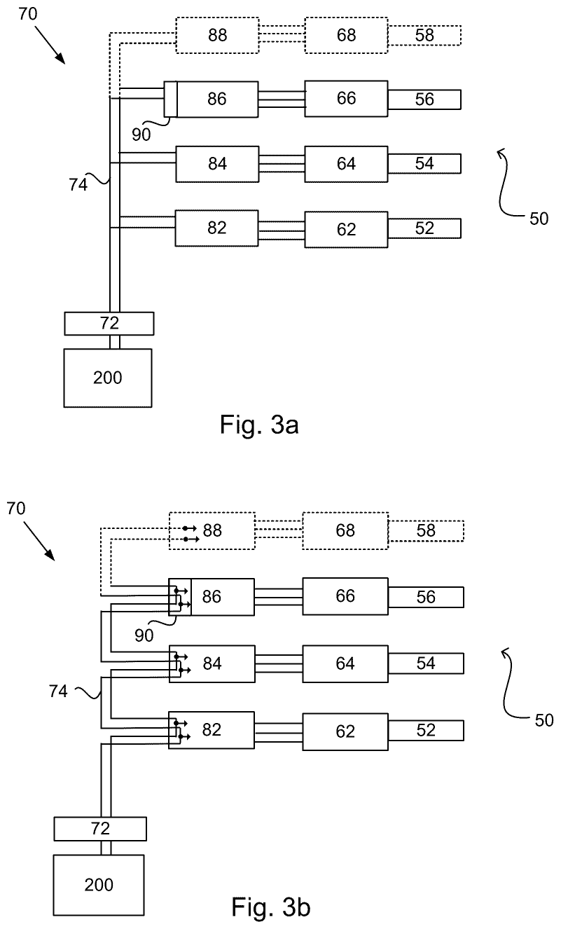

FIGS. 3a-b schematically show a power distribution assembly 70 of a crane arm according to examples of the present disclosure. The crane arm may be configured as disclosed in FIG. 1 or 2 and thus comprises a set of electro-mechanical actuators 50 with electric motors 62, 64, 66. The set of actuators 50 comprises a first actuator 52, a second actuator 54, and a third actuator 56. As previously described, the power distribution assembly 70 comprises an interface 72 for receiving a DC power signal from a DC power source 200, and a set of spatially distributed power converting units 80 configured to convert the DC power signal to an AC power signal for the respective electric motor 62,64, 66 of the set of actuators 50.

In these examples, the power converting units 82, 84, 86 of the set of power converting units 80 are connected in a connection sequence for distributing the DC power signal. Thus, the power converting units 82, 84, 86 are connected to a common power input source 74 transferring the DC power signal, such that the same DC power signal is received of all power converting units 82, 84, 86. The connection sequence of the power converting units 82, 84, 86 may e.g. be implemented by connecting the power converting units 82,84,86 in a parallel daisy chain for distributing the DC power signal as shown in FIG. 3b, or using a T-connection to connect the power converting units 82,84,86 in parallel as shown in FIG. 3a.

As shown in the figures, the last power converting unit 86 in the sequence may comprise an interface 90 for optional connection with an additional power converting unit 88, herein called a fourth power converting unit 88. The fourth power converting unit 88 may be configured to convert the DC power signal to an AC power signal for an electric motor 68 of an actuator 58 operating for example a crane tool or a jib arm connected to the crane arm 100. Such crane tools and jib arms may often be mounted to the crane arm 100 for specific applications, e.g. when the crane operator is to perform a lift of e.g. roof tiles to the roof of a building under construction a jib arm is often used for additional reach. The same crane may later be used for delivering other types of goods where a pallet fork with a rotator may be used and the tools and jib arms may hence be adapted to the application.

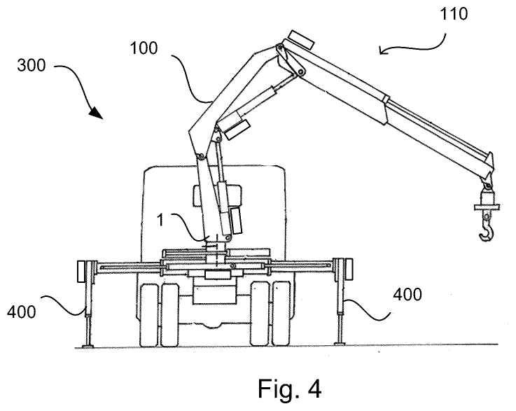

FIG. 4 shows a vehicle 300 with a working equipment 110 according to an example of the present disclosure. The working equipment 110 is a loader crane and comprises a crane arm 100 as disclosed in any of FIG. 1-3. The working equipment 110 comprises a rotatable crane column forming part of the crane assembly 1 supporting the crane arm 100. The crane column may be rotated by electrically powered actuators powered by the power distribution assembly 70 of the crane arm 100. The working equipment 110 further comprises extendable stabilizer legs 400 operated by electrically powered actuators. Said actuators may be powered by the power distribution assembly 70 of the crane arm 100.

The vehicle 300 and/or the working equipment 110 may comprise a DC power source 200 operably connected to the power distribution assembly 70 of the crane arm 100 via the interface 72 for receiving a DC power signal.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A crane arm (100) comprising:
a first boom (10) configured to be movably connected to a crane assembly (1) for supporting the crane arm (100);
a second boom (20) movably connected to the first boom (10); and
a set of electrically powered actuators (50) powered by AC power signals, the set of actuators (50) comprising at least a first actuator (52) with a first electric motor (62) and a second actuator (54) with a second electric motor (64),
wherein the first actuator (52) is arranged to move the first boom (10) in relation to the crane assembly (1) and the second actuator (54) is arranged to move the second boom (20) in relation to the first boom (10), characterized in that the crane arm (100) further comprises:
a power distribution assembly (70) including:
an interface (72) for receiving a DC power signal; and
a set of spatially distributed power converting units (80) arranged to convert the DC power signal to an AC power signal for a respective electric motor (62,64) of the set of actuators (50), the set of power converting units (80) comprising at least a first power converting unit (82) for the first electric motor (62) and a second power converting unit (84) for the second electric motor (64),
wherein each power converting unit of the set of power converting units (80) is arranged adjacent to the respective electric motor (62, 64) of the set of actuators (50).

2. The crane arm (100) according to claim 1, wherein the set of electrically powered actuators (50) comprises electro-mechanical actuators (52, 54).

3. The crane arm (100) according to claim 1, wherein the first and second power converting units (82, 84) are arranged on different parts (10, 20, 52, 54) of the crane arm (100) or crane assembly (1), the parts being arranged to move in relation to each other.

4. The crane arm (100) according to claim 1, wherein the second power converting unit (84) is arranged on the first boom (10).

5. The crane arm (100) according to claim 1, wherein the second boom (20) is a telescopic boom comprising at least one extendable and retractable third boom (30), wherein the set of actuators (50) comprises a third actuator (56) with a third electric motor (66) arranged to move the third boom (30) and the set of power converting units (80) comprises a third power converting unit (86) arranged to convert the DC power signal to an AC power signal for the third electric motor (66).

6. The crane arm (100) according to claim 1, wherein at least one power converting unit (82, 84, 86) of the set of power converting units (80) is arranged on the actuator (52, 54, 56) associated with the electric motor (62, 64, 66) receiving the AC power signal from the power converting unit (82, 84, 86).

7. The crane arm (100) according to claim 1, wherein the power converting units (82, 84, 86) of the set of power converting units (80) are connected in a connection sequence for distributing the DC power signal.

8. The crane arm (100) according to claim 1, wherein the power distribution assembly (70) is operably connectable to a DC power source (200) via the interface (72) for receiving a DC power signal.

9. The crane arm (100) according to claim 1, wherein at least one power converting unit (82, 84, 86) of the set of power converting units (80) comprises an interface (90) for connection with an additional power converting unit (88).

10. The crane arm (100) according to claim 9, wherein the additional power converting unit (88) is configured to convert the DC power signal to an AC power signal for an electric motor (68) of an actuator (58) operating a crane tool or a jib connected to the crane arm (100).

11. A working equipment (110) comprising a crane arm (100) according to claim 1.

12. The working equipment (110) according to claim 11, further comprising a crane assembly (1) with a rotatable crane column and/or extendable stabilizer legs (400) operated by electrically powered actuators powered by the power distribution assembly (70).

13. The working equipment (110) according to claim 11, wherein the working equipment (110) is configured to be arranged on a vehicle (300).

14. The working equipment (110) according to claim 11, further comprising a DC power source (200) operably connected to the power distribution assembly (70) via the interface (72) for receiving a DC power signal.

15. A vehicle (300) comprising a working equipment (110) according to claim 11, wherein the vehicle (300) further comprises a DC power source (200) operably connected to the power distribution assembly (70) via the interface (72) for receiving a DC power signal.
